(19) United States
(12) Patent Application Publication
(10) Pub. No.: US 2025/0335992 A1
(43) Pub. Date: Oct. 30, 2025

(54) SPECTRUM MANAGEMENT METHOD AND SPECTRUM MANAGEMENT DEVICE

(71) Applicant: GUANGDONG OPPO MOBILE TELECOMMUNICATIONS CORP., LTD., Dongguan (CN)

(72) Inventor: Hao LIN, Neuilly-sur-Seine (FR)

(21) Appl. No.: 19/260,192

(22) Filed: Jul. 3, 2025

Related U.S. Application Data
(63) Continuation of application No. PCT/IB2023/000038, filed on Jan. 6, 2023.

(51) Int. Cl. G06Q 40/04; G06Q 20/38; G06Q 30/08

(52) U.S. Cl. CPC G06Q 40/04; G06Q 20/389; G06Q 30/08

(57) ABSTRACT

A spectrum management method and a spectrum management device are disclosed. The spectrum management method includes adjusting a right of a spectrum block using a blockchain. The spectrum management device includes an adjuster configured to adjust a right of a spectrum block using a blockchain.

### CROSS-REFERENCE TO RELATED APPLICATION

This is a continuation application of International Patent Application No. PCT/IB2023/000038, filed on Jan. 6, 2023, the disclosure of which is hereby incorporated by reference in its entirety.

### BACKGROUND OF DISCLOSURE

### 1. Field of the Disclosure

The present disclosure relates to the field of communication systems, and more particularly, to a spectrum management method and a spectrum management device, which can provide flexible spectrum sharing.

### 2. Description of the Related Art

To resolve the incumbency of the traditional spectrum management and to further improve the spectrum utilization efficiency as well as to motivate the spectrum holder in terms of higher return in investment, there is a need for flexible spectrum sharing.

### SUMMARY

An object of the present disclosure is to propose a spectrum management method and a spectrum management device, which can improve the spectrum utilization efficiency and/or provide flexible spectrum sharing.

In a first aspect of the present disclosure, a spectrum management method includes adjusting a right of a spectrum block using a blockchain.

In a second aspect of the present disclosure, a spectrum management device includes an adjuster configured to adjust a right of a spectrum block using a blockchain. Further, the spectrum management device is configured to perform any one of the above methods.

In a third aspect of the present disclosure, a spectrum management device includes a memory, a transceiver, and a processor coupled to the memory and the transceiver. The processor is configured to perform any one of the above methods.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a spectrum management device in a communication network system according to an embodiment of the present disclosure.

FIG. 2 is a flowchart illustrating a spectrum management method according to an embodiment of the present disclosure.

FIG. 3 is a schematic diagram of a first level granularity for a utilization right trading according to an embodiment of the present disclosure.

FIG. 4 is a schematic diagram of a data structure according to an embodiment of the present disclosure.

FIG. 5 is a schematic diagram of a second level of granularity for a utilization right trading according to an embodiment of the present disclosure.

FIG. 6 is a schematic diagram of adjusting a right of a spectrum block using a blockchain according to an embodiment of the present disclosure.

FIG. 7 is a block diagram of a spectrum management device according to an embodiment of the present disclosure.

FIG. 8 is a block diagram of a system for spectrum management according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

### Blockchain

A blockchain is a type of distributed ledger technology (DLT) that includes growing lists of records, called blocks, that are securely linked together using cryptography. Each block contains a cryptographic hash of the previous block, a timestamp, and transaction data (generally represented as a Merkle tree, where data nodes are represented by leaves). The timestamp proves that the transaction data existed when the block was created. Since each block contains information about the previous block, they effectively form a chain (compare linked list data structure), with each additional block linking to the ones before it. Consequently, blockchain transactions are irreversible in that, once they are recorded, the data in any given block cannot be altered retroactively without altering all subsequent blocks.

Blockchains can be managed by a peer-to-peer (P2P) computer network for use as a public distributed ledger, where nodes collectively adhere to a consensus algorithm protocol to add and validate new transaction blocks. Blockchain records are not unalterable, since blockchain forks are possible, blockchains may be considered secure by design and exemplify a distributed computing system with high Byzantine fault tolerance.

### Spectrum Management

In a simple approach, government divides spectrum into non-overlapping blocks. Licenses are then distributed, where a license gives its recipient the exclusive right to transmit in one such block of spectrum in a given geographic region. Clearly, exclusive access solves the problem of mutual interference with no need for coordination (although there can be opportunities for some negotiations along spectral and geographic boundaries, where guard bands are generally needed). Consequently, most spectrum throughout the world is licensed in this manner. However, the drawback of exclusive spectrum licensing yields: 1) the spectrum allocation process takes length duration; 2) the deployment of a selected new technology cannot realize all of sudden, resulting in a low return in investment; 3) the government needs to spend extra effort to monitor whether efficient spectrum utilization is ensured in practice.

It is important to notice that a timely penetration to the market is a key to promote a new technology, e.g., in 80's the VHS beat Beta in video-recording market, not because VHS is a better technology but thanks to the VHS two-hours tape came to market a few months earlier. Thus, a length spectrum distributing process sometimes may kill a good technology.

### Technical Problem

To resolve the incumbency of the traditional spectrum management and to further improve the spectrum utilization efficiency as well as to motivate the spectrum holder in terms of higher return in investment, in this disclosure, some embodiments present a concept of flexible spectrum sharing. The new flexible spectrum sharing is realized with the help of blockchain infrastructure and distributed ledger technology.

FIG. 1 illustrates that, in some embodiments, a spectrum management device 10 in a communication network system 30 (e.g., non-terrestrial network (NTN) or terrestrial network) according to an embodiment of the present disclosure is disclosed. The communication network system 30 includes the spectrum management device 10. The spectrum management device 10 may include a memory 12, a transceiver 13, and a processor 11 coupled to the memory 12 and the transceiver 13. The processor 11 may be configured to implement proposed functions, procedures and/or methods described in this description. Layers of radio interface protocol may be implemented in the processor 11. The memory 12 is operatively coupled with the processor 11 and stores a variety of information to operate the processor 11. The transceiver 13 is operatively coupled with the processor 11, and the transceiver 13 transmits and/or receives a radio signal.

The processor 11 may include application-specific integrated circuit (ASIC), other chipset, logic circuit and/or data processing device. The memory 12 may include read-only memory (ROM), random access memory (RAM), flash memory, memory card, storage medium and/or other storage device. The transceiver 13 may include baseband circuitry to process radio frequency signals. When the embodiments are implemented in software, the techniques described herein can be implemented with modules (e.g., procedures, functions, and so on) that perform the functions described herein. The modules can be stored in the memory 12 and executed by the processor 11. The memory 12 can be implemented within the processor 11 or external to the processor 11 in which case those can be communicatively coupled to the processor 11 via various means as is known in the art.

In some embodiments, the processor 11 is configured to adjust a right of a spectrum block using a blockchain. This can improve the spectrum utilization efficiency and/or provide flexible spectrum sharing.

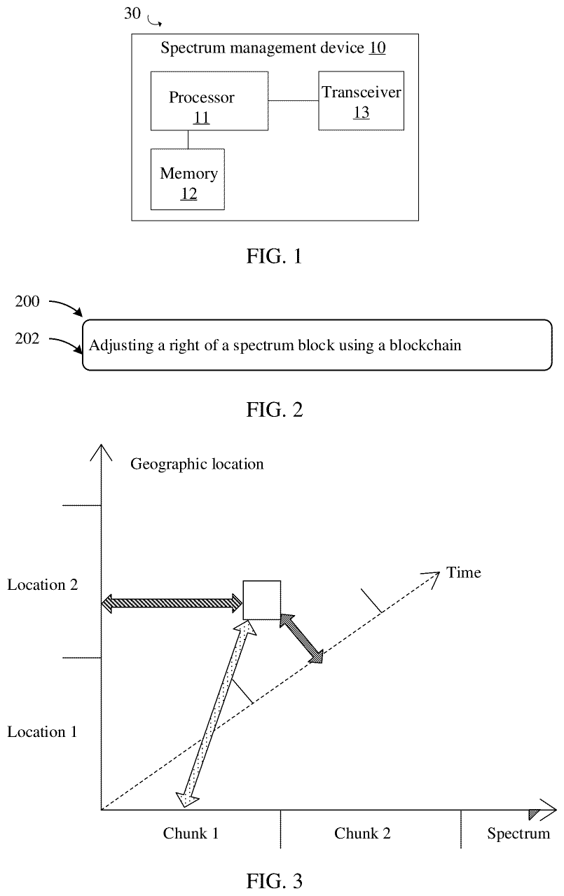

FIG. 2 illustrates a spectrum management method 200 according to an embodiment of the present disclosure. In some embodiments, the method 200 includes: a block 202, adjusting a right of a spectrum block using a blockchain. This can improve the spectrum utilization efficiency and/or provide flexible spectrum sharing.

In some embodiments, the right of the spectrum block includes a utilization right of the spectrum block, a property right of the spectrum block, and/or an ownership of the spectrum block. In some embodiments, adjusting the right of the spectrum block is based on a first level of granularity. In some embodiments, the first level of granularity includes a frequency domain, a time domain, a spatial domain, and/or a geographic domain. In some embodiments, the blockchain includes a node dedicated to a utilization right trading of the spectrum block. In some embodiments, the blockchain includes a consortium chain. In some embodiments, a node over the blockchain is a consortium member or approved by the consortium. In some embodiments, a node in the blockchain has a node account with an account address used to serve as an identity of the node. In some embodiments, the node account includes information for the utilization right trading of the spectrum block.

In some embodiments, the information for the utilization right trading of the spectrum block includes an account balance used for a trade payment and information relevant to an authentication, and the authentication is used to prove that a user is allowed to participate to the utilization right trading of the spectrum block. In some embodiments, the utilization right trading of the spectrum block includes an auction or a non-auction. In some embodiments, the auction includes creating a smart contract for the auction and sharing a smart contract address to all nodes who are interested in participating in the auction. In some embodiments, a condition to call the smart contract includes at least one of the followings: the consortium member, a user account having enough money in a balance account of the user account to trigger a bid, and a user having authentication to participate in the utilization right trading of the spectrum block. In some embodiments, creating the smart contract for the auction is based on a technology dimension, and/or the money includes a coin or a token. In some embodiments, the technology dimension includes one or more technologies to be used in the spectrum block.

In some embodiments, the one or more technologies include at least new radio (NR), a 3GPP technology, or a Wi-Fi or an IEEE technology. In some embodiments, the smart contract includes a bidding expiration time or remaining time, a holder ID or a holder signature, a holder smart contract account address, a bid amount each time the smart contract being called/triggered. In some embodiments, after creating the smart contract, the smart contract is published over the blockchain by a blockchain miner. In some embodiments, when the smart contract is triggered, the smart contract checks if the bidding expiration time or remaining time is met, if so, the smart contract is no longer triggered.

In some embodiments, when the smart contract is triggered, the smart contract checks if the bidding expiration time or remaining time is met, if not, the smart contract continues to check if user conditions are all met, then the smart contract automatically executes a fee transaction of an amount of a pre-defined bid from a user balance account to a smart contract account and updates a latest user identifier (ID) or address with a highest bid. In some embodiments, when the bidding expiration time or remaining time is over, the smart contract automatically transfers a final amount of bided money from the smart contract account to a holder account and returns money to accounts of all users who lost the auction. In some embodiments, the smart contract records data about a fee transaction of the spectrum utilization right in a ledger, and the smart contract further updates a utilization right data structure. In some embodiments, the non-auction requests a fixed trading fee. In some embodiments, in the non-auction, when a smart contract is called/triggered by a user, a transaction is conducted, and the utilization right is issued.

In some embodiments, to call the smart contract, the user's money in a balance account is equal to or greater than a requested trading fee, and/or the user obtains an authentication. In some embodiments, when multiple users successfully call the smart contract, the utilization right is issued to multiple users. In some embodiments, when there are multiple users obtain the utilization right within a same frequency chunk for a same time period and geographic location, the user performs a collision avoidance access rule. In some embodiments, the smart contract is created to control a number of the users so that a collision level is not high. In some embodiments, a maximum number of calling the smart contract is set, every time the smart contract is successfully called by the user, a number of calling the smart contract is decremented until zero. In some embodiments, once the number of calling the smart contract reaches zero, the smart contract is not called/triggered again, achieving a control of the number of users that are issued with the utilization right.

In some embodiments, the right of the spectrum block is allowed to further being traded in a second market. In some embodiments, the right of the spectrum block is traded in the second market based on a second level of granularity. In some embodiments, the second level of granularity is a layering of the first level of granularity. the second level of granularity includes a frequency domain, a time domain, a spatial domain, and/or a geographic domain.

The examples given in this disclosure can be applied for IoT device, NB-IoT device, NR device, LTE device, but the present disclosure is not limited thereto.

### Examples

In order to resolve the technical problem, it is important to find a way to adjust the spectrum utilization right or property right. In the traditional spectrum management, the spectrum utilization right is allocated by the government via licensing. An operator obtains the spectrum block license, and the operator then has the right to access the spectrum block. However, the spectrum licensing is not flexible, and it is not easy to be adjusted. In some embodiments of the present disclosure, the utilization right and/or the property right of a spectrum block can be allocated and later on can also be adjusted, meaning that the right of a spectrum block can be transferred from one holder to another holder.

In some embodiments, the government initiates a coarse spectrum utilization right distribution to a certain number of users, where the user could be but not limited to traditional operators. Then the users become the utilization right holders, we call it holders in short. The holders are allowed to transfer their utilization right to other users, in return the holders can obtain benefit, e.g., fees, from the utilization right trading. Since the holders may transfer the spectrum block, which is not in use for its own service, and such situation may be varying in time and/or geographic locations. Thus, this could allow the holder to decide a finer granularity for the utilization right trading. For example, besides the frequency domain, some embodiments can add at least two more dimensions, i.e., time domain and geographic domain as illustrated in FIG. 3, where the spectrum block can be further divided into chunk, the time can be divided into a pre-defined time frame, such as hours, days, months, etc. The geographic dimension could define the granularity of the geographic domain, one example could be the national-defined geographic area, e.g., street, block, city, department, region, etc. Alternatively, it could also be defined by GPS locations. When the holder wants to trade the spectrum utilization right, the holder may trade one or more frequency chunks which he has the utilization rights, and once the utilization right is transferred, the new holder only has the right within the defined time frame and the defined geographic location. This finer granularity can bring more flexibility for the initial holder so that the holder may be more motivated to perform such trade.

In some embodiments, the utilization right trade is realized over blockchain. First of all, the initial holder and the user who wants to be the potential new holder should be a node in a blockchain dedicated to utilization right trading. One example is that such blockchain could be a consortium chain and the consortium can be established by the government authority, operators, blockchain infrastructure builders, etc. To become a node over the blockchain, one needs to become a consortium member or be approved by the consortium. A node can have a node account with an account address, which serves as an identity of the node. In the account there may be one or more information for the trading, such as the account balance which is used for the trade payment and information relevant to authentication, where the authentication is used to prove that the user is allowed to participate to the trading. This authentication may be issued by the government authority or other party. The user can be authenticated if certain conditions are met. For example, one condition could be the certification to test when the user uses the spectrum, its equipment satisfies the regulation, is controlled out-of-band interference requirement, or conforms to a standard of a target/requested technology, e.g., new radio (NR), a 3GPP technology, or a Wi-Fi or an IEEE technology. The trading can take the form of auction or non-auction. For auction trading, the holder may set an initial price for the target spectrum chunk and call for auction. The potential users can bid for the utilization right. The auction process is described as follows: the holder creates a smart contract for the auction and shares the smart contract address to all the nodes who are interested to participate to the auction. In some embodiments, creating the smart contract for the auction is based on a technology dimension. In some embodiments, the technology dimension includes one or more technologies to be used in the spectrum block. In some embodiments, the one or more technologies include at least new radio (NR), a 3GPP technology, or a Wi-Fi or an IEEE technology.

In the smart contract, it may precise all the granularity information as previously presented and the conditions to call the smart contract are at least one of the followings: 1) the consortium member; 2) the user account has enough money in his balance account to trigger the bid; 3) the user has authentication to participate the trade. In some embodiments, money includes a coin or a token.

The smart contract may be programs stored on a blockchain that run when one or more predetermined conditions are met. The smart contract is used to automate the execution of an agreement so that all participants can be immediately certain of the outcome, without any intermediary's involvement or time loss. The smart contact can also automate a workflow, triggering a next action when one or more conditions are met.

Coins refer to any cryptocurrency that has a standalone, independent blockchain, like Bitcoin. These cryptocurrencies are bootstrapped from scratch, and the broader network is designed explicitly to achieve a certain goal. For example, Bitcoin exists as a censorship-resistant store of value and medium of exchange that has a secure, fixed monetary policy. The native token of Bitcoin, BTC (i.e., bitcoins), is the most liquid cryptocurrency in the market and has both the highest market cap and realized market cap in the cryptocurrency sector. Coin projects typically draw inspiration from past technologies or other cryptocurrencies and fuse them into an innovative network catering to a specific purpose. Another example of a coin, Ethereum's Ether (ETH) is the native coin of a smart contracts platform for creating general-purpose computer programs that run on a decentralized blockchain. Rather than focusing on financial data, Ethereum focuses on arbitrary program data that can cover anything from games to social media. Ether is used for sending/receiving, managing assets, paying gas fees, and interacting with decentralized applications on the network.

Tokens are a unique outlay of broader smart contracts platforms like Ethereum that enable users to create, issue, and manage tokens that are derivatives of the primary blockchain. Tokens occupy a unique corner of the cryptocurrency market where they function as “utility” tokens within an application's ecosystem for incentivizing certain behavior or paying fees. A token may refer to a digital unit of value that represents an asset or utility. Unlike coins, tokens do not have their own blockchain and are issued on top of existing networks. Unlike coins, tokens are not mined in the process of transaction validation. Instead, they are minted.

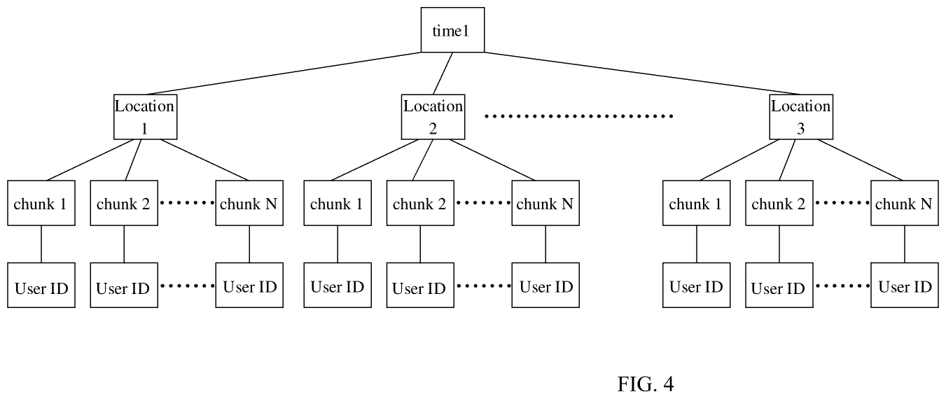

Other than these, the smart contract may contain other information such as bidding expiration time or remaining time; holder ID or holder signature; holder smart contract account address; the bid amount each time is contract is called/triggered. After creating the smart contract, the smart contract can be published over the blockchain by blockchain miner. In return, the holder may obtain a contract address, with which the potential users can call the smart contract. The holders may share the address with the potential users. As a potential user, he can use the smart contract address to trigger the smart contract for bidding the auction. Once the smart contract is triggered, it may first check if the expiration time is met, if so, the user can no longer trigger the smart contract. But if not, the smart contract will continue to check if the user conditions are all met, the smart contract can automatically execute the fee transaction of an amount of the pre-defined bid from the user balance account to the smart contract account and updates the latest user ID (or address) with the highest bid. When the auction expiration time is over, the smart contract may automatically transfer the final amount of bided money from the smart contract account to the holder account and at the same time returns the money to the account of all the users who lost the auction. Then the smart contract will record the data about the spectrum utilization right fees transaction in the ledger and also the smart contract will update the utilization right data structure. An example of the data structure can be depicted in FIG. 4.

For non-auction, on the other hand, the non-auction requests a fixed trading fee. It means that when the smart contract is called/triggered by a user, the transaction will be conducted, and the utilization right can be issued. Similarly, to call the smart contract, the user conditions must be met such as the user's money in the balance account must be equal to or greater than the requested trading fee; the user needs to obtain the authentication. In this case, it is to note that when multiple users successfully called the smart contract, the utilization right may be issued to multiple users. When there are multiple users obtain the utilization right within a same frequency chunk for a same time period and geographic location, the user needs to perform collision avoidance access rule, such as listen-before-talk (LBT). The smart contract can be created to control the number of the users so that the collision level may not be high. For example, the holder may set a maximum number of calling the smart contract, every time the smart contract is successfully called by a user, the number may be decremented until zero. Once the number reaches zero, the smart contract cannot be called/triggered again, achieving the control of the number of users that are issue with utilization rights.

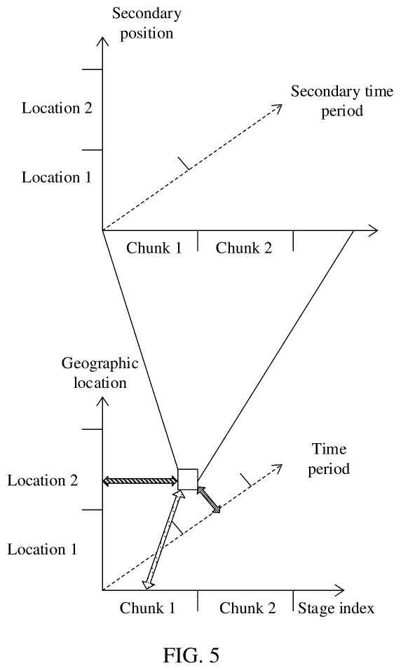

In another example, when a user obtains the utilization right via the above described process, the user may be allowed to further trade his right in a second market. To enable a full flexibility, the user may decide to trade the utilization right in a second level of granularity as illustrated in FIG. 5.

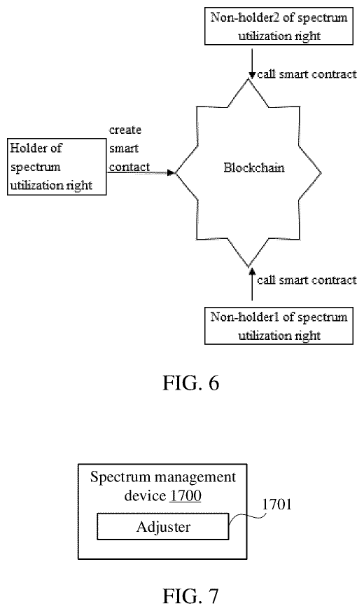

FIG. 6 illustrates adjusting a right of a spectrum block using a blockchain according to an embodiment of the present disclosure. FIG. 6 illustrates that, in some embodiments, a holder of spectrum utilization right may create a smart contact using a blockchain, a first non-holder of spectrum utilization right may call the smart contact using a blockchain, and a second non-holder of spectrum utilization right may call the smart contact using a blockchain. In some embodiments, it is understood that, when multiple users such as the first and second non-holders of spectrum utilization right, successfully call the smart contract, the utilization right may be issued to the multiple users. When there are multiple users obtain the utilization right within a same frequency chunk for a same time period and geographic location, the user needs to perform collision avoidance access rule, such as listen-before-talk (LBT). The smart contract can be created to control the number of the users so that the collision level may not be high. For example, the holder may set a maximum number of calling the smart contract, every time the smart contract is successfully called by a user, the number may be decremented until zero. Once the number reaches zero, the smart contract cannot be called/triggered again, achieving the control of the number of users that are issue with utilization rights.

FIG. 7 illustrates a spectrum management device 1700 according to an embodiment of the present disclosure. The spectrum management device 1700 includes an adjuster 1701 configured to adjust a right of a spectrum block using a blockchain. This can improve the spectrum utilization efficiency and/or provide flexible spectrum sharing.

In some embodiments, the right of the spectrum block includes a utilization right of the spectrum block, a property right of the spectrum block, and/or an ownership of the spectrum block. In some embodiments, the adjuster 1701 is configured to adjust the right of the spectrum block is based on a first level of granularity. In some embodiments, the first level of granularity includes a frequency domain, a time domain, a spatial domain, and/or a geographic domain. In some embodiments, the blockchain includes a node dedicated to a utilization right trading of the spectrum block. In some embodiments, the blockchain includes a consortium chain. In some embodiments, a node over the blockchain is a consortium member or approved by the consortium. In some embodiments, a node in the blockchain has a node account with an account address used to serve as an identity of the node. In some embodiments, the node account includes information for the utilization right trading of the spectrum block.

In some embodiments, the information for the utilization right trading of the spectrum block includes an account balance used for a trade payment and information relevant to an authentication, and the authentication is used to prove that a user is allowed to participate to the utilization right trading of the spectrum block. In some embodiments, the utilization right trading of the spectrum block includes an auction or a non-auction. In some embodiments, the auction includes creating a smart contract for the auction and sharing a smart contract address to all nodes who are interested in participating in the auction. In some embodiments, a condition to call the smart contract includes at least one of the followings: the consortium member, a user account having enough money in a balance account of the user account to trigger a bid, and a user having authentication to participate in the utilization right trading of the spectrum block. In some embodiments, creating the smart contract for the auction is based on a technology dimension, and/or the money includes a coin or a token. In some embodiments, the technology dimension includes one or more technologies to be used in the spectrum block.

In some embodiments, the one or more technologies include at least new radio (NR), a 3GPP technology, or a Wi-Fi or an IEEE technology. In some embodiments, the smart contract includes a bidding expiration time or remaining time, a holder ID or a holder signature, a holder smart contract account address, a bid amount each time the smart contract being called/triggered. In some embodiments, after creating the smart contract, the smart contract is published over the blockchain by a blockchain miner. In some embodiments, when the smart contract is triggered, the smart contract checks if the bidding expiration time or remaining time is met, if so, the smart contract is no longer triggered.

In some embodiments, when the smart contract is triggered, the smart contract checks if the bidding expiration time or remaining time is met, if not, the smart contract continues to check if user conditions are all met, then the smart contract automatically executes a fee transaction of an amount of a pre-defined bid from a user balance account to a smart contract account and updates a latest user identifier (ID) or address with a highest bid. In some embodiments, when the bidding expiration time or remaining time is over, the smart contract automatically transfers a final amount of bided money from the smart contract account to a holder account and returns money to accounts of all users who lost the auction. In some embodiments, the smart contract records data about a fee transaction of the spectrum utilization right in a ledger, and the smart contract further updates a utilization right data structure. In some embodiments, the non-auction requests a fixed trading fee. In some embodiments, in the non-auction, when a smart contract is called/triggered by a user, a transaction is conducted, and the utilization right is issued.

In some embodiments, to call the smart contract, the user's money in a balance account is equal to or greater than a requested trading fee, and/or the user obtains an authentication. In some embodiments, when multiple users successfully call the smart contract, the utilization right is issued to multiple users. In some embodiments, when there are multiple users obtain the utilization right within a same frequency chunk for a same time period and geographic location, the user performs a collision avoidance access rule. In some embodiments, the smart contract is created to control a number of the users so that a collision level is not high. In some embodiments, a maximum number of calling the smart contract is set, every time the smart contract is successfully called by the user, a number of calling the smart contract is decremented until zero. In some embodiments, once the number of calling the smart contract reaches zero, the smart contract is not called/triggered again, achieving a control of the number of users that are issued with the utilization right.

In some embodiments, the right of the spectrum block is allowed to further being traded in a second market. In some embodiments, the right of the spectrum block is traded in the second market based on a second level of granularity. In some embodiments, the second level of granularity is a layering of the first level of granularity. the second level of granularity includes a frequency domain, a time domain, a spatial domain, and/or a geographic domain.

Commercial interests for some embodiments are as follows. 1. Improving the spectrum utilization efficiency. 2. Providing flexible spectrum sharing. 3. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in 5G NR licensed and non-licensed or shared spectrum communications. Some embodiments of the present disclosure propose technical mechanisms.

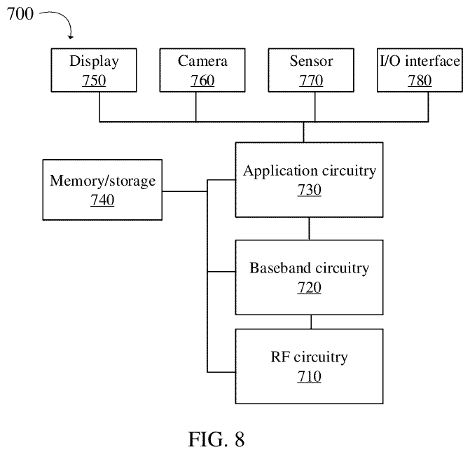

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A spectrum management method, comprising:
adjusting a right of a spectrum block using a blockchain.

2. The method of claim 1, wherein the right of the spectrum block comprises a utilization right of the spectrum block, a property right of the spectrum block, and/or an ownership of the spectrum block.

3. The method of claim 1, wherein adjusting the right of the spectrum block is based on a first level of granularity, and wherein the first level of granularity comprises a frequency domain, a time domain, a spatial domain, and/or a geographic domain.

4. The method of claim 1, wherein the blockchain comprises a node dedicated to a utilization right trading of the spectrum block.

5. The method of claim 1, wherein the blockchain comprises a consortium chain, and a node over the blockchain is a consortium member or approved by the consortium.

6. The method of claim 1, wherein a node in the blockchain has a node account with an account address used to serve as an identity of the node.

7. The method of claim 6, wherein the node account comprises information for the utilization right trading of the spectrum block, and the information for the utilization right trading of the spectrum block comprises an account balance used for a trade payment and information relevant to an authentication, and the authentication is used to prove that a user is allowed to participate to the utilization right trading of the spectrum block.

8. The method of claim 4, wherein the utilization right trading of the spectrum block comprises an auction or a non-auction.

9. The method of claim 8, wherein the auction comprises creating a smart contract for the auction and sharing a smart contract address to all nodes who are interested in participating in the auction.

10. The method of claim 9, wherein a condition to call the smart contract comprises at least one of the followings: the consortium member, a user account having enough money in a balance account of the user account to trigger a bid, and a user having authentication to participate in the utilization right trading of the spectrum block.

11. The method of claim 9, wherein creating the smart contract for the auction is based on a technology dimension, and/or the money comprises a coin or a token.

12. The method of claim 9, wherein the smart contract comprises a bidding expiration time or remaining time, a holder ID or a holder signature, a holder smart contract account address, a bid amount each time the smart contract being called/triggered.

13. The method of claim 9, wherein when the smart contract is triggered, the smart contract checks if the bidding expiration time or remaining time is met, if not, the smart contract continues to check if user conditions are all met, then the smart contract automatically executes a fee transaction of an amount of a pre-defined bid from a user balance account to a smart contract account and updates a latest user identifier (ID) or address with a highest bid.

14. The method of claim 12, wherein when the bidding expiration time or remaining time is over, the smart contract automatically transfers a final amount of bided money from the smart contract account to a holder account and returns money to accounts of all users who lost the auction.

15. The method of claim 14, wherein the smart contract records data about a fee transaction of the spectrum utilization right in a ledger, and the smart contract further updates a utilization right data structure, and wherein when multiple users successfully call the smart contract, the utilization right is issued to multiple users.

16. The method of claim 15, wherein when there are multiple users obtain the utilization right within a same frequency chunk for a same time period and geographic location, the user performs a collision avoidance access rule.

17. The method of claim 15, wherein a maximum number of calling the smart contract is set, every time the smart contract is successfully called by the user, a number of calling the smart contract is decremented until zero.

18. The method of claim 1, wherein the right of the spectrum block is allowed to further being traded in a second market.

19. A spectrum management device, comprising:
an adjuster configured to adjust a right of a spectrum block using a blockchain.

20. A spectrum management device, comprising:
a memory;
a transceiver; and
a processor coupled to the memory and the transceiver;
wherein the processor is configured to:
adjust a right of a spectrum block using a blockchain.
